(19) United States
(12) Patent Application Publication
(10) Pub. No.: US 2004/0032420 A1
(43) Pub. Date: Feb. 19, 2004

(54) Interactive benchmarking system

(76) Inventors: Bradley J. Allen, West Chester, PA (US); David F. Earley, Franklin, MA (US); Graham D. Ward, Duluth, GA (US)

Correspondence Address: SAMUEL BORODACH, Fish & Richardson P.C., Suite 2800, 45 Rockefeller Plaza, New York, NY, 10111, US

(21) Appl. No.: 10/278,244

(22) Filed: Oct. 23, 2002

Related U.S. Application Data
(60) Provisional application No. 60/403,197, filed on Aug. 13, 2002.

(51) Int. Cl. G09G 5/00

(52) U.S. Cl. 345/700

(57) ABSTRACT

In response to receiving user input specifying a dataset and a display format, an interactive benchmarking system displays aggregated benchmark data based on the specified dataset and display format. The benchmarking data may include, for example, financial or operational data. Users may access the data sets selectively and use the data as a basis of comparison to provide benchmarks of a particular organization's operational and financial performance.

### CROSS-REFERENCE TO RELATED APPLICATIONS

This application claims the benefit of priority of U.S. Provisional Application No. 60/403,197, filed Aug. 13, 2002, and incorporated herein by reference.

### BACKGROUND

This disclosure relates to an interactive benchmarking system.

One technique that allows a business or other organization to assess its financial and operational performance in a competitive market is to compare its performance against the performance of other businesses operating in the market. To permit such comparisons to be made, the organization needs access to current, reliable and relevant data. In addition to comparing its performance to the detailed financial and operational information for a particular company, an organization may compare its performance to data for a peer group of companies. Such data can provide benchmarking criteria to assist the organization in evaluating its performance in the marketplace.

### BRIEF DESCRIPTION OF THE DRAWINGS

FIG. 1 illustrates an example of an architecture for a benchmarking system.

FIG. 2 illustrates a screen to allow users to perform data entry and access benchmark data.

FIGS. 3-8 illustrate screens relating to data entry.

FIGS. 9-12 illustrate screens relating to accessing selected benchmark data.

FIGS. 13-17 illustrate screens with user options relating to graphing and charting capabilities.

FIGS. 18-19 illustrate examples of exported spreadsheets with benchmark data.

FIGS. 20-23 illustrate screens of a scenario analysis feature.

### SUMMARY

The subject matter relates to an interactive benchmarking system. In response to receiving user input specifying a dataset and a display format, the system displays aggregated benchmark data based on the specified dataset and display format. The benchmarking data may include, for example, financial or operational data. Users may access data sets selectively and use the data as a basis of comparison to provide benchmarks of a particular organization's operational and financial performance.

Various implementations may include one or more of the following features. The benchmark data may be searched, for example, by industry or geographic location as well as by North American Industrial Classification (NAIC) or other codes. The system may allow the user to specify a particular format in which to display the selected benchmark data. The display format may be selected from among various options.

One or more of the following advantages may be present in some implementations. For example, the benchmark system may provide users with greater flexibility in choosing which benchmark data to view and in what format the data should be displayed. The system can deliver financial and operational data to facilitate analysis and evaluation across industries and revenue ranges. The ability to sort the benchmarking data by revenue range, for example, may enable users to focus their evaluation and review data from companies that most closely match their own company. Furthermore, the system's graphing and charting capabilities may allow users to develop customized reports tailored to their business size and industry. The flexibility provided by the system may give users improved insight into their own business and allow them to identify more easily and accurately areas of strength and weakness based on the benchmark data.

Other features and advantages will be readily apparent from the following detailed description, the accompanying drawings and the claims.

### DETAILED DESCRIPTION

An interactive, on-line computer system, described in greater detail below, can provide businesses or other organizations with access to aggregated operational and financial evaluation data. Operational and financial data may be accumulated from many businesses. The data then may be processed to provide the aggregated benchmark data. Financial and operational metrics may be sorted according to the companies' revenue ranges to enable an organization to perform an evaluation based on data from companies that most closely match its own revenue range. Data sets may be accessed selectively and used as a basis of comparison to provide benchmarks of a particular organization's operational and financial performance. The datasets may be searched, for example, by industry and geographic location as well as by using North American Industry Classification (NAIC) or other classification codes. The industry data sets may be subdivided into sub-industry groups which, in turn, may be divided into sub-sub-industry groups to allow searching of more narrowly defined industry groups.

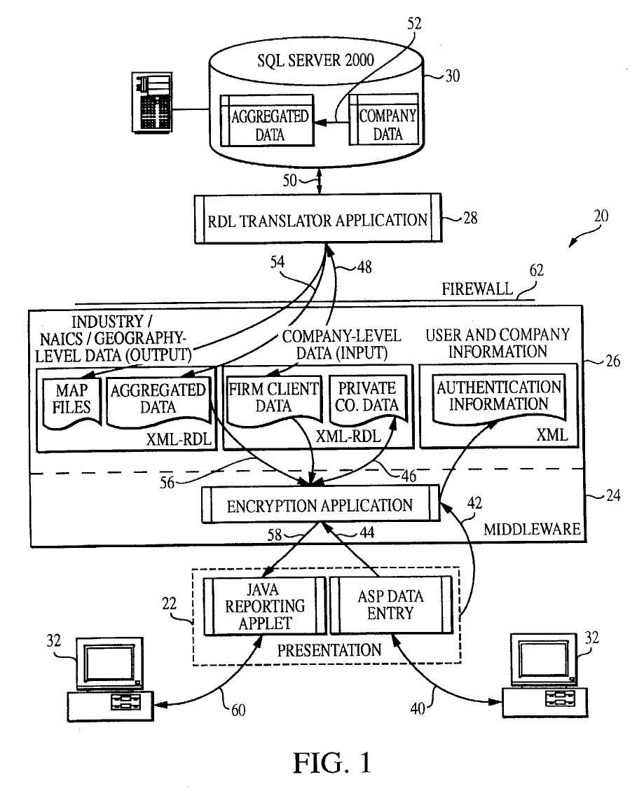

As illustrated in FIG. 1, a particular implementation of the interactive benchmarking system 20 may include an n-tier architecture with several active application layers and a supporting layer that exists outside of the application's direct execution. A presentation tier 22 serves as the interface between a user and a computer network such as the Internet that provides access to the World Wide Web. Activities such as data entry, administration, and reporting may be performed through the presentation tier. Supporting technologies may include, for example, HyperText Markup Language (HTML) and Active Server Pages (ASP) for data entry and reporting, and HTML and Java language for reporting. A user may gain access to the Internet, for example, through a personal computer 32 with a browser. Other user devices may provide the access to the Internet as well. An application tier 24 includes middleware to manage the relationship between user actions and the data. The application tier may handle, for example, user authentication and data encryption.

A data tier 26 may include Extensible Markup Language (XML) files that contain benchmark data, company data and user data. The data may be utilized by the application for content and administrative purposes. In addition, the metric information may be encrypted. A storage and data processing tier 30 includes a Structured Query Language (SQL) server-database which may exist outside of the application's execution environment and which contains the company data that comprises the benchmarks. The storage and data processing tier 30 also may serve as a platform that executes business rules for aggregating data. A firewall 62 or other security features may be provided to enhance security.

The flow of information in the particular architecture of FIG. 1 is as follows. A user may enter 40 financial and operational data about a company into the system. Input forms for entering the data may be based, for example, on Microsoft ASP. In some implementations, input logic may be in an ASP page resident in the middleware tier 24. Next, authentication information is passed 42 to the application, and data is passed 44 to an encryption layer. The data passed from the encryption application may be stored 46 in Resource Description Framework (RDL) formatted XML files in the data tier 26. Client data is passed 48 through an RDL translator 28 and is loaded 50 into the database. Next, SQL stored procedures are executed to aggregate 52 company data according to industry, geographic and revenue range benchmarks. The aggregated benchmark data is routed 54 back through the RDL translator 28 and applied to the application web server.

When a user makes a request for data, the relevant data is passed 56 to the encryption application, which provides 58 the decrypted data to a reporting applet. The aggregated information may be presented 60, for example, through a Java-based reporting applet, which provides a Javascript interface to allow for the dynamic loading and unloading of benchmark and company data sets.

The architecture of the system illustrated in FIG. 1 is intended as an example. Other implementations may use a different architecture.

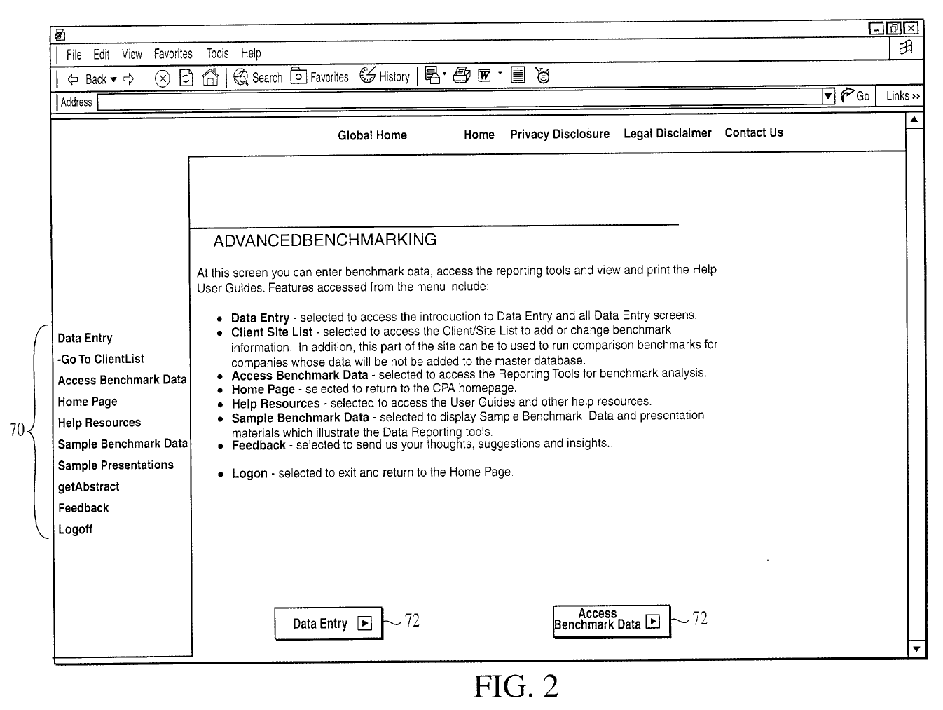

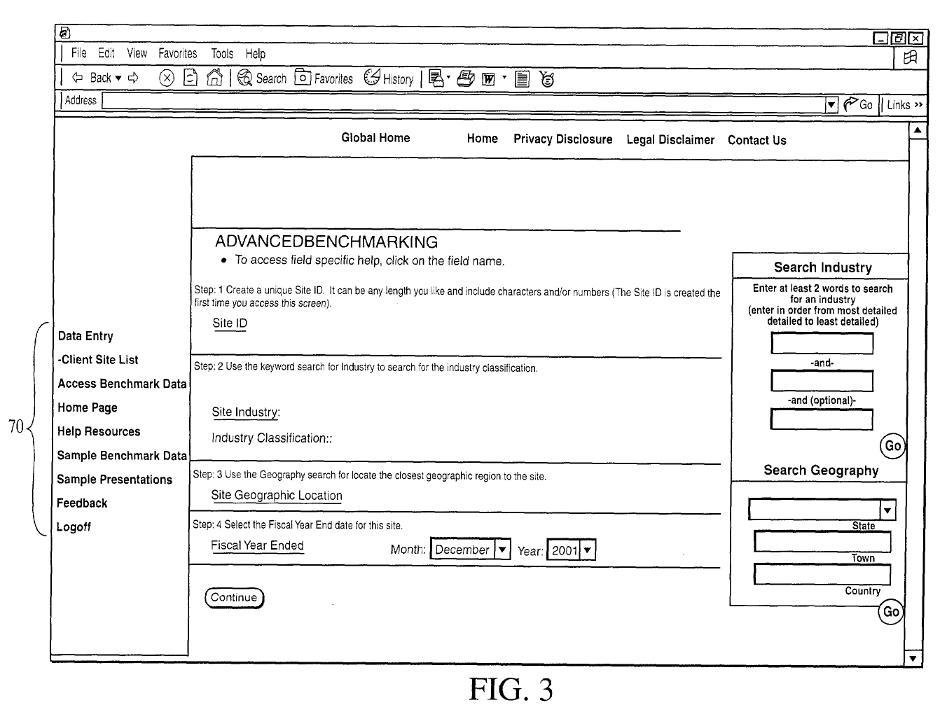

To use the system, a user may access a website from the personal computer 32 or other user device. A user can select one of several options from a navigation bar 70 (FIG. 2) appearing on the user's display screen. The options include (i) data entry and (ii) access to benchmark data. Alternatively, the user can select one of those options by clicking an appropriate one of the buttons 72. Selecting the data entry option allows the user to enter financial and operational data for a particular company. As illustrated by the display screen of FIG. 3, to enter financial and operational data, the user initially creates a unique identification for the particular company and identifies the industry classification and geographic location of the company. The industry classification and geographic location are selected from predetermined lists. Examples of industry classifications include (i) accommodation and food services, (ii) agriculture, forestry, fishing and hunting, (iii) construction, (iv) finance and insurance, (v) manufacturing, (vi) real estate, (vii) mining, (viii) professional, scientific and technical services, (ix) retail trade and (x) utilities, among others. As previously mentioned, each industry classification may be sub-divided into more narrowly defined categories. A keyword search feature may be used to identify the appropriate industry classification as well as the closest geographic location. The user also enters the month and year corresponding to the end date of the company's fiscal year. The month and year may be selected, for example, from a drop-down menu or entered directly using a keyboard.

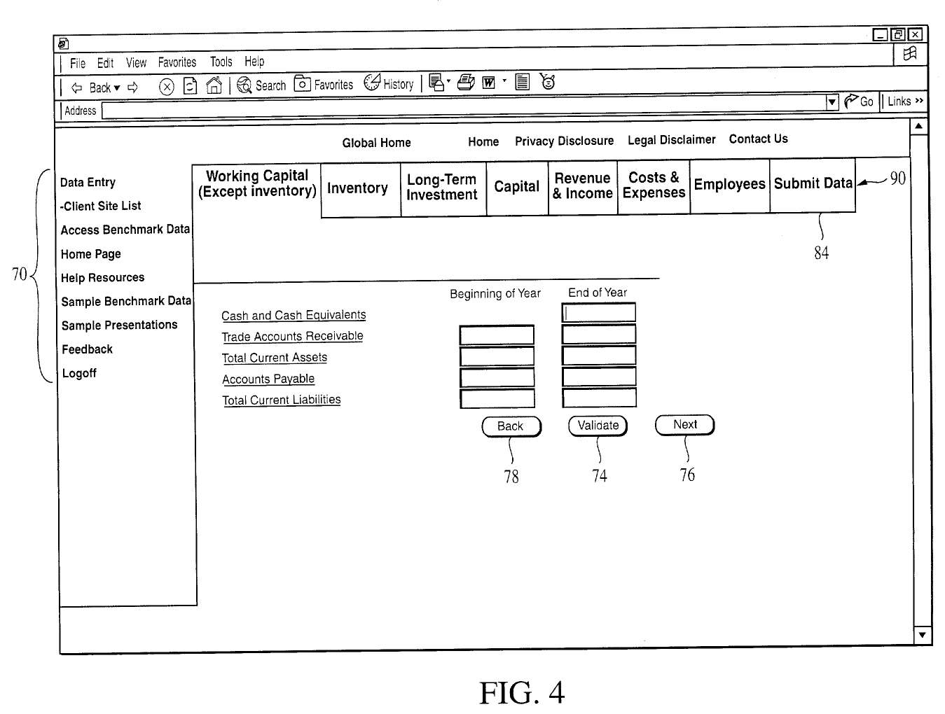

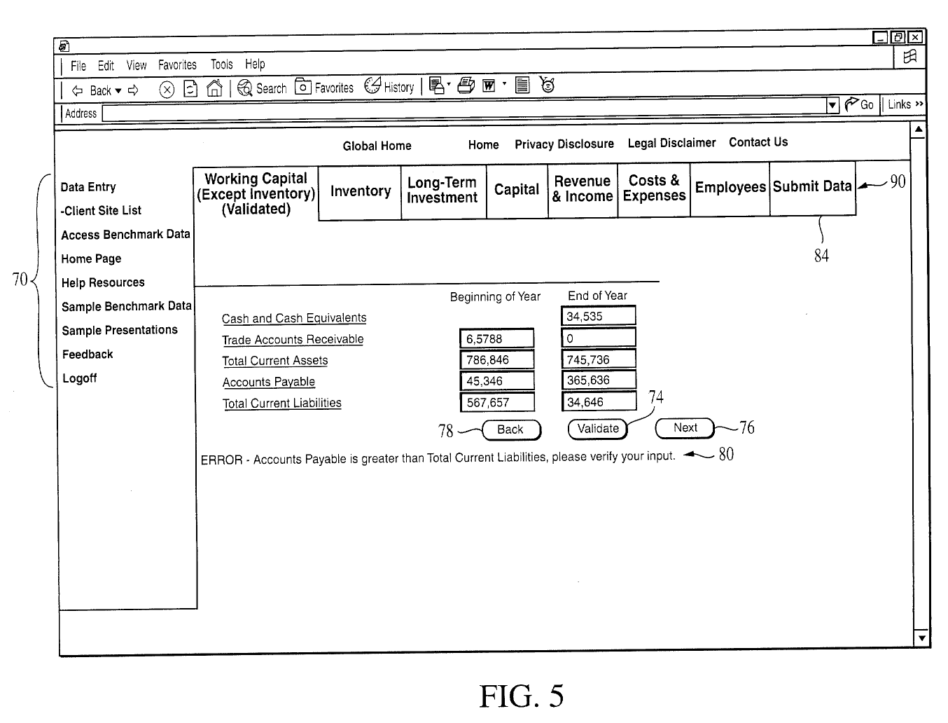

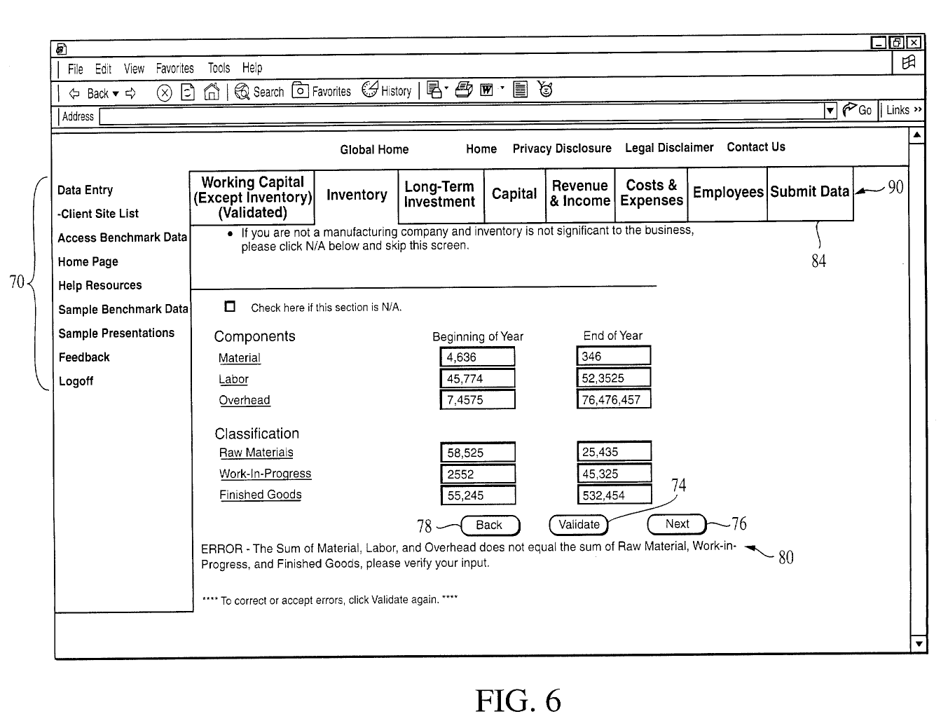

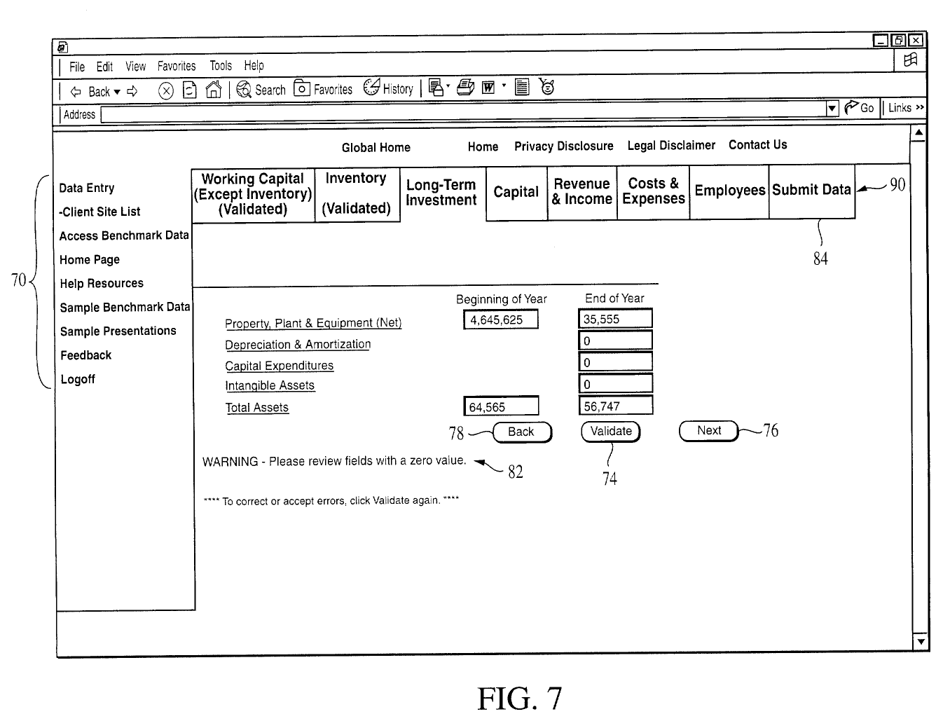

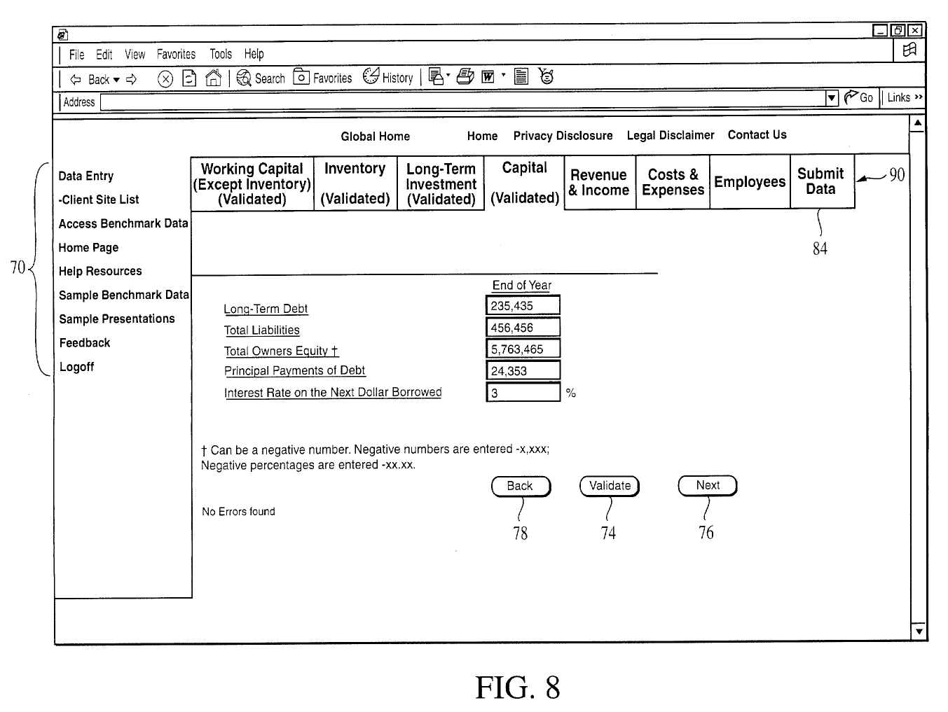

As illustrated by FIG. 4, data entry may be performed according to predefined categories (e.g., working capital other than inventory, inventory, long-term investment, capital, revenue and income, costs and expenses, and employee information). Additional or different categories may be used in other implementations. FIGS. 4 and 5 illustrate a data entry screen for the “working capital” category. FIGS. 6, 7 and 8 illustrate data entry screens for the “inventory,” “long-term investment” and “capital” categories, respectively.

Once the data fields for a particular category are completed, the user may click a “validate” button 74 on the user's computer screen to cause the benchmarking tool to execute a predetermined series of arithmetic and statistical formulas to identify potential omissions and errors in the entered data. As shown in FIGS. 5, 6 and 7, error messages 80 and warnings 82 may be generated automatically for data fields whose value falls outside parameters defined by the formulas or whose value was entered as a zero. The benchmarking tool may prompt the user to review the entries to confirm that the data is correct or to correct the data. To proceed to the next data entry category, the user clicks the NEXT button 76. To return to a previous category, the user may click the BACK button 78. Alternatively, a particular category can be selected by clicking on one of the tabs 90. After the data for a particular category has been validated, a message or other indicator appears in the corresponding tabs 90 to indicate that the data has been validated (see, e.g., FIGS. 5-8).

After entering and validating the data for each of the categories, the user may click the “Submit Data” tab 84. The system may execute another series of arithmetic and statistical formulas to confirm the overall consistency of the entered data for the particular company. The system automatically identifies uncorrected entries that may have an impact on the analysis so that the user or an administrator can confirm the data is correct before it is accepted and incorporated into the aggregated data.

Once the data is accepted by the system, the system uses the data to calculate various predetermined metrics. The calculated metrics are then incorporated into the appropriate aggregated data set(s) depending on the industry and other characteristics of the company. The metrics may relate, for example, to (i) financial information, (ii) financial ratios or (iii) operating metrics. The financial information metrics may relate, for example, to balance sheet information, cash flow information or income statement information. The financial ratios metrics may relate, for example, to liquidity ratios, activity ratios, leverage ratios or profitability ratios. The operating metrics may relate, for example, to investment ratios, productivity, cost per unit sales, cost per full time equivalent (FTE) employee, percent of outsourced costs, employee turnover or coverage ratios. Additional or different metrics may be calculated and aggregated in other implementations.

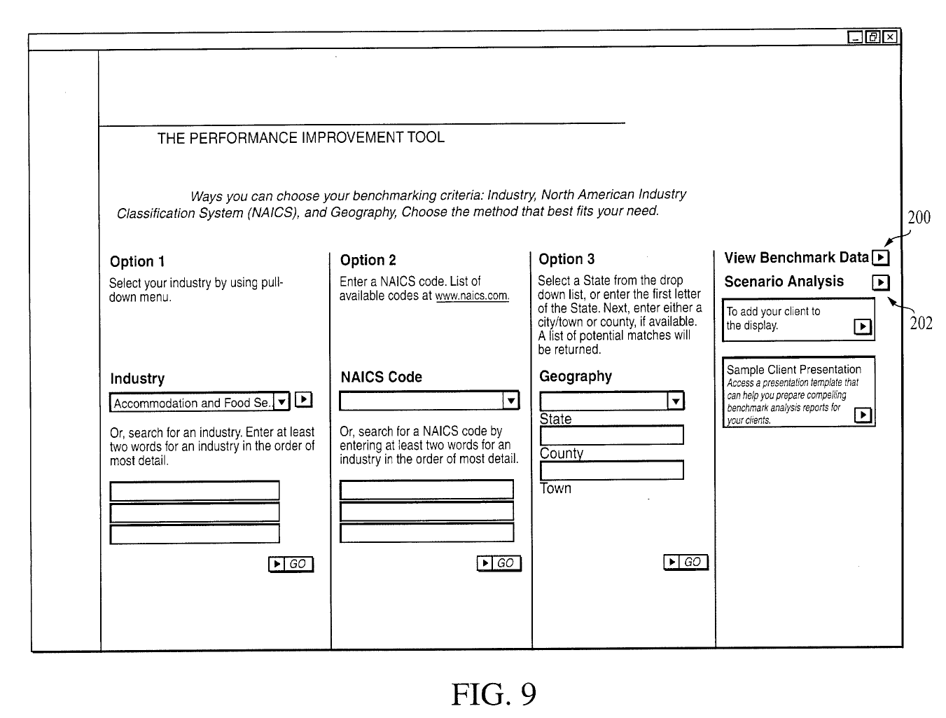

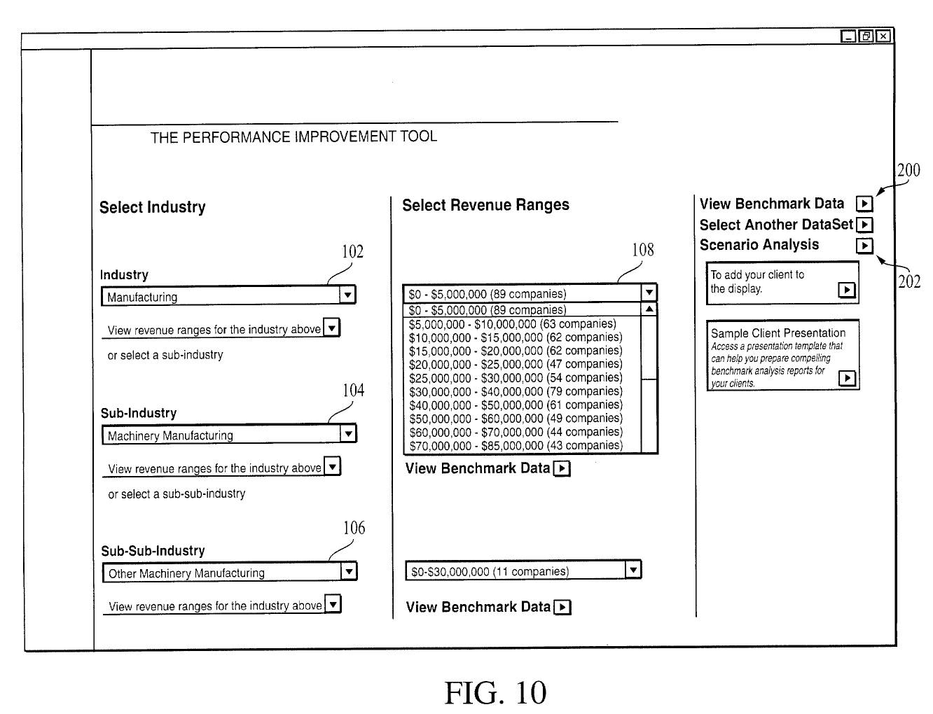

As previously mentioned, a user may access the benchmarking data according to various criteria such as industry, geographic location or industry classification code (see FIG. 9). As illustrated in FIG. 10, to access benchmark data according to industry, the user may select an industry, sub-industry or sub-sub-industry from one or more drop-down menus 102, 104, 106. In addition, the user may select a revenue range using a corresponding drop-down menu 108. Selecting a revenue range allows the user to restrict the accessed benchmark data to the data for companies whose revenue falls within the specified range.

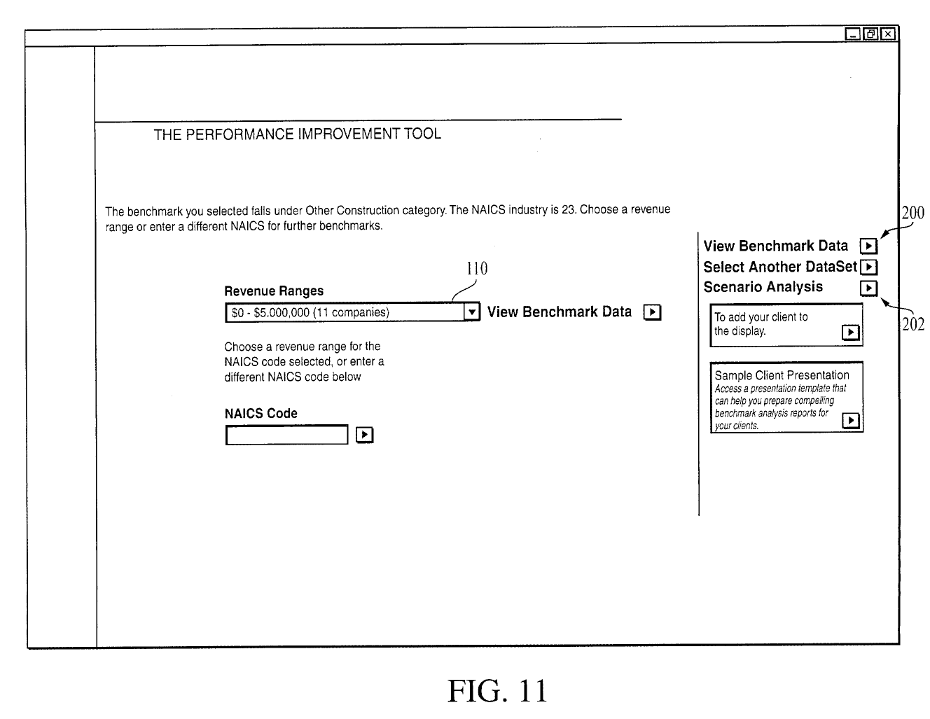

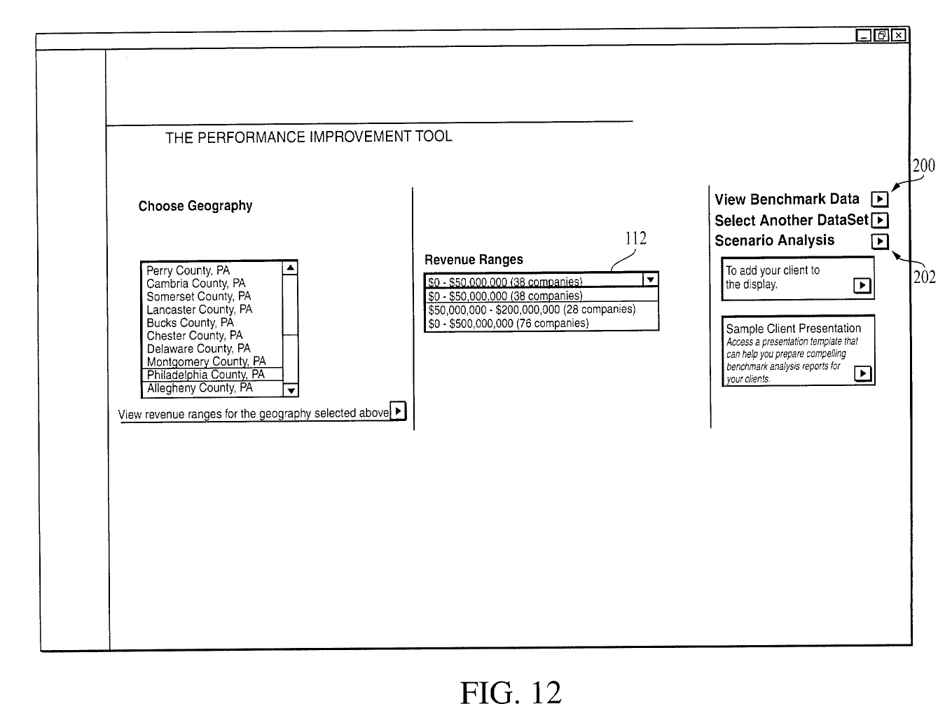

Similarly, to access benchmark data according to industry classification, the user may enter or select an industry classification code, such as an NAIC code, and may select a revenue range from the pull-down menu 110 (FIG. 11). To access benchmark data according to geographical location, the user may enter or select the location and may select a revenue range from the pull-down menu 112 (FIG. 12).

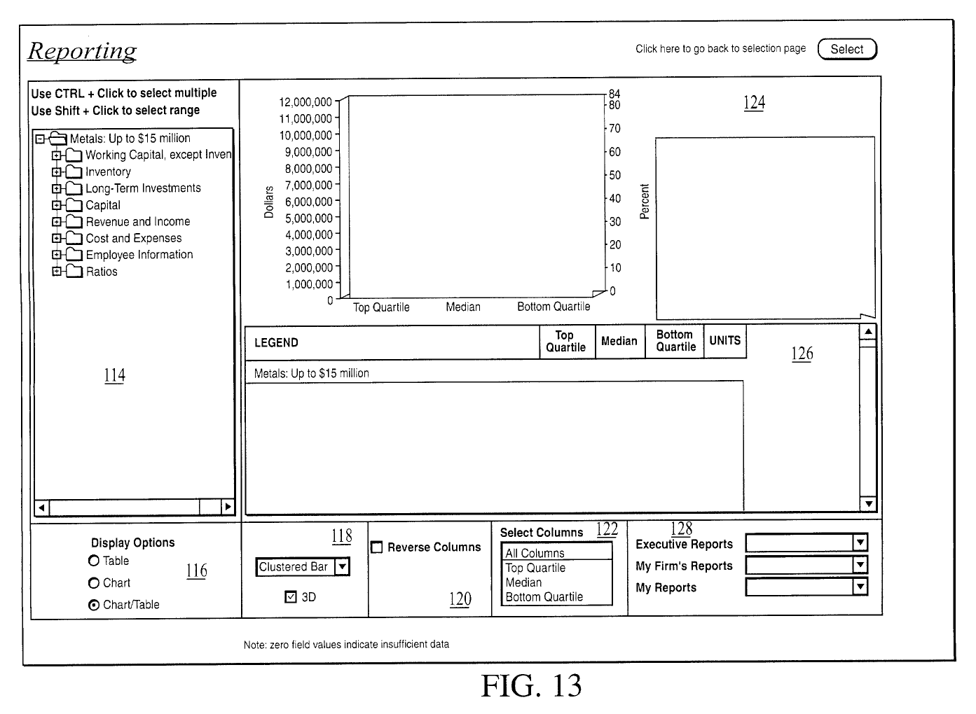

Once the user selects a data set, the user may view the benchmark data by clicking the button 200 labeled “View benchmark data” (FIGS. 9-12) A reporting screen appears as shown, for example, in FIG. 13. In this example, it is assumed that the user selected the metals industry and an annual revenue range of $0-$15 million. From the reporting screen, the user may select one or more metrics from any of the categories listed in the area 114 on the left-hand side of the screen. By clicking on a particular category, the user can scroll through a list of specific metrics in that category and can select which metrics the user wishes to display.

The screen also provides a variety of user-selectable display options to allow the user to customize the display of selected data. For example, display options in area 116 may allow the user to choose the format in which the data is to be displayed. Display format options may include displaying the data as a table, a chart or both. The user also may select the type of chart (e.g., clustered bar, stacked bar, area, line, pie) in which the data is to be displayed from a drop-down menu in area 118 of the screen. A three-dimensional (3D) option may be selected to provide an enhanced display. Charts of the benchmark data may be displayed, for example, in one area 124 of the screen, and tables of the benchmark data may be displayed in another area 126.

The user may select which performance quartiles (e.g., all quartiles, top quartile, median quartile, bottom quartile) or other segments are to be displayed, as well as the order in which they are to be displayed by clicking on the appropriate options in the areas 120, 122. In other implementations, the data may be sub-divided into broader or narrower segments.

Another area 128 of the screen may allow the user to select from among various previously established filters. For example, “Executive Reports” may include a series of filters that enable users to capture high level information quickly with a single click of an electronic mouse. “My Firm's Reports” may include list filters created by users in a particular firm to allow other persons in the same firm to share those filters. “My Reports” may include list filters that a user creates for his or her own use.

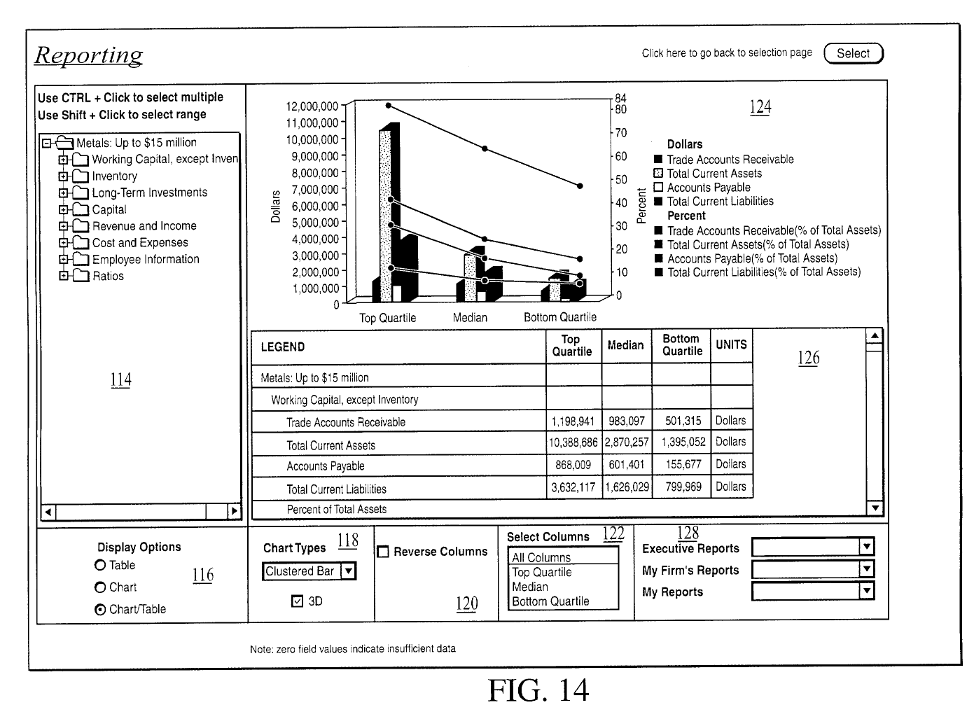

FIG. 14 illustrates an example of a report in which eight different metrics from the category “Working capital (except inventory)” are displayed in both chart and table format for the metals industry based on the dataset of companies with an annual revenue of up to $15 million. Thus, multiple data point comparisons may be shown on the same display. In this example, all quartiles are displayed in a single cluster bar chart as well as in a single table. Depending on the size of the screen, the user may need to scroll through the table to view all the information. The particular metrics for which benchmark data is displayed in this example are (i) trade accounts receivable, (ii) total current assets, (iii) accounts payable, (iv) total current liabilities, (v) trade accounts receivable as a percentage of total assets, (vi) total current assets as a percentage of total assets, (vii) accounts payable as a percentage of total assets and (viii) total current liabilities as a percentage of total assets. In this case, the first four metrics are displayed in units of dollars, whereas the latter four metrics are displayed by percentage. In other words, a single chart may be used to display the various metrics whose units differ. The information in the chart may be color-coded to facilitate presentation of the benchmark data, with a key to the data provided adjacent the chart.

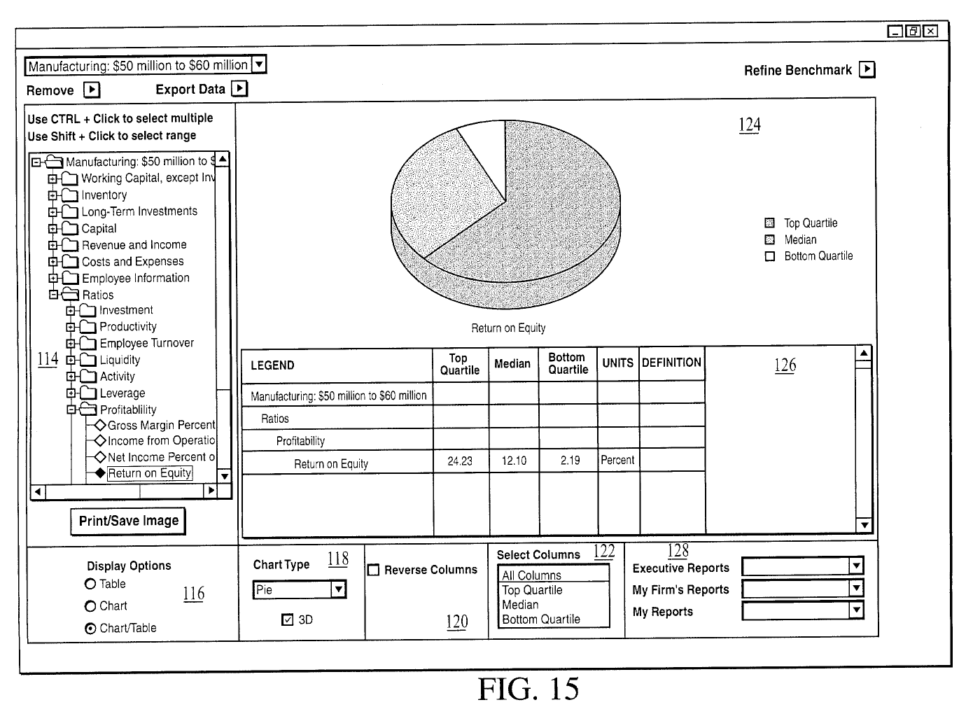

FIG. 15 illustrates an example of a report in which benchmark data for a single metric, “return on equity,” is displayed in pie chart format as well as table format based on the dataset for manufacturing companies with an annual revenue in the range of $50 million to $60 million. To generate this report, the user would select the appropriate industry and revenue range from the screens in FIGS. 9 and 10. Then the user would select the metric “return on equity” from area 114 of the screen (FIG. 15) as well as the “chart/table” option in area 116 of the screen and the “pie” option from the drop-down menu in area 118 of the screen.

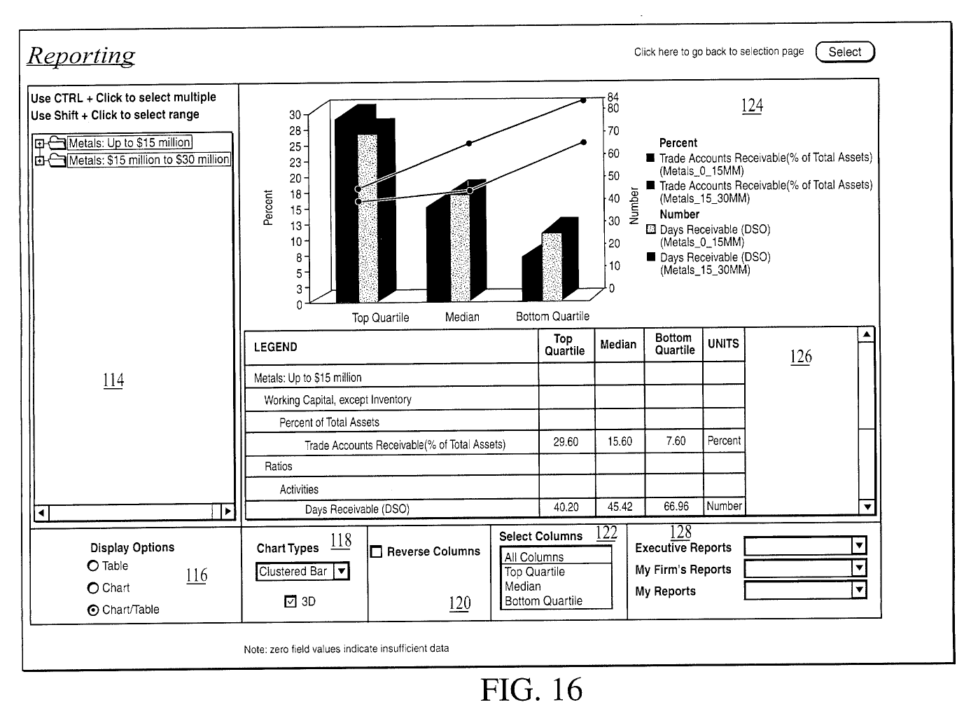

FIG. 16 illustrates an example of a report in which one or more metrics for different revenue ranges may be displayed simultaneously in either a chart format, a table format or both. In this example, data for the metrics “trade accounts receivable” and “days receivable (DSO)” is displayed based on the dataset for metals companies with annual revenues in the ranges of $0 to $15 million and $15 million to $30 million, respectively.

In general, the system is designed to display aggregated financial and operational data representing multiple companies rather than the data of a single, specific company. However, in some implementations, the system may allow a user to view data for a specific company, for example, if the user has one of several specified relationships with the particular company. Each user may be given an identification code to be used when accessing the system. The user's identification code would determine which companies' data the user may view on an individual basis.

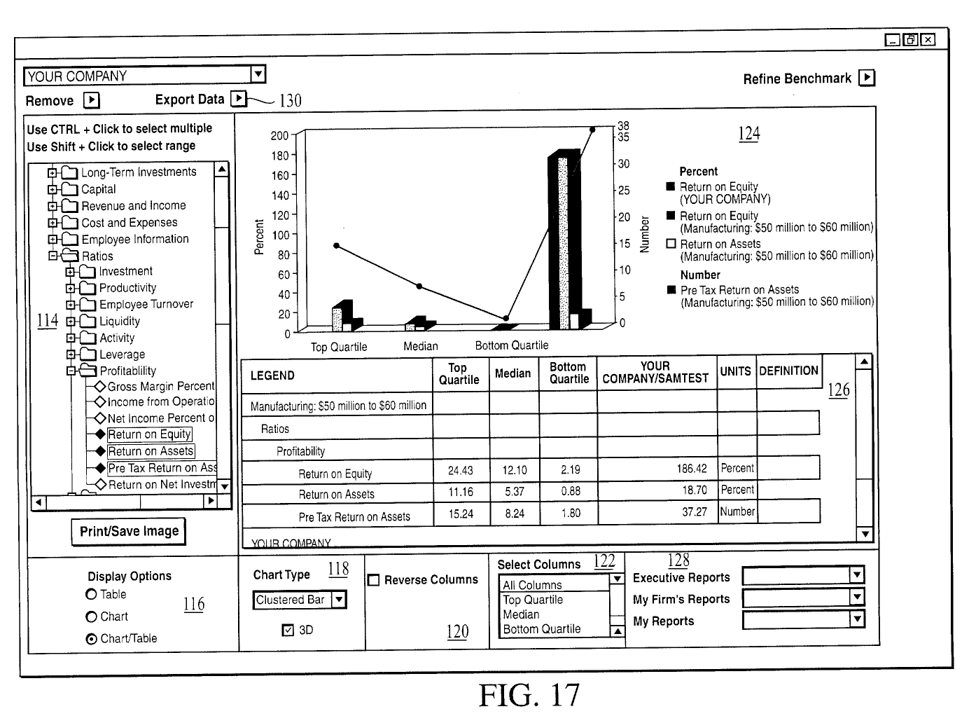

FIG. 17 illustrates an example of a report in which data for a particular company (YOUR COMPANY) is compared in chart and table format to aggregated benchmark data based on the dataset for manufacturing companies with an annual revenue in the range of $50 million to $60 million. Thus, the selected, aggregated benchmark data may be displayed alongside data for a particular company. In this case, the percentage of “return on equity” is displayed for the particular company and for the aggregated benchmark data. In addition, the percentage of “return on assets” is displayed for the manufacturing companies with an annual revenue in the range of $50 million to $60 million. Similarly, benchmark data for “pre-tax return on assets” is displayed for those same manufacturing companies.

The selected data may be saved or shared, and in some implementations, may be exported, for example, to a spreadsheet in the form of a static report. For example, to export the data to a spreadsheet, the user may click a button 130 (see, e.g., FIG. 17). Various indicators may be provided on the spreadsheet to indicate where on the spectrum a particular organization falls with respect to a particular metric compared to the aggregated benchmark data.

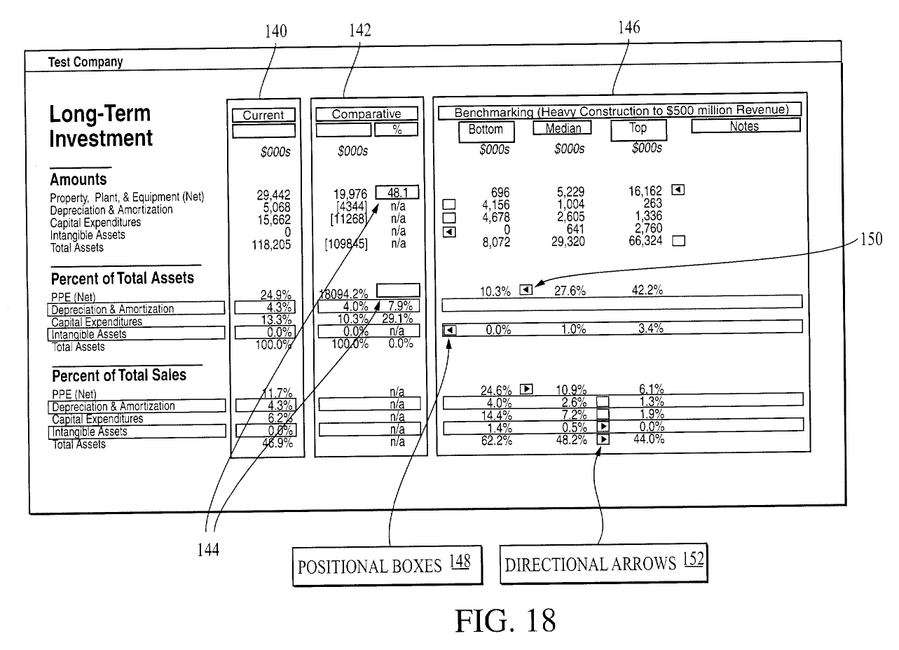

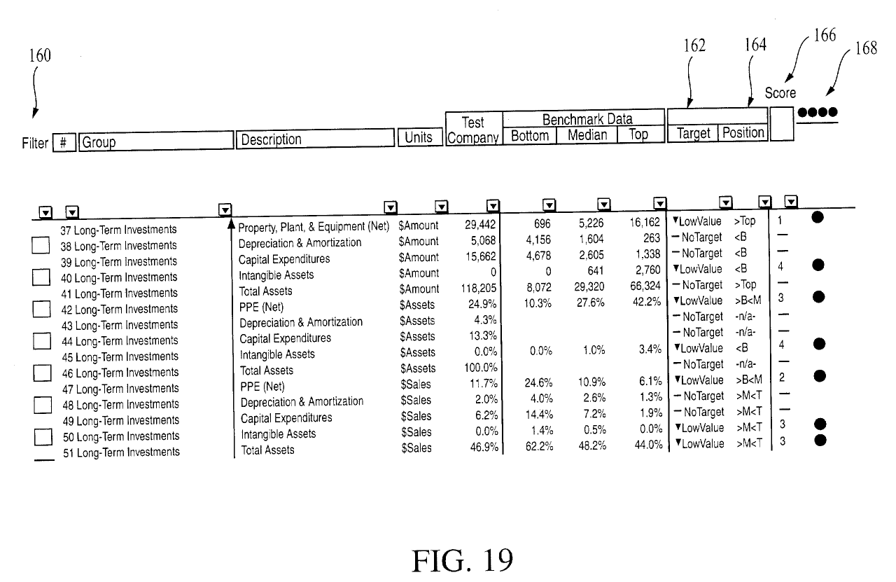

FIGS. 18 and 19 illustrate examples of spreadsheets that include exported benchmark data. For example, as shown in FIG. 18, the spreadsheet may include columns 140, 142 that list the current values and comparative values for various metrics for a particular company. The comparative values may include an indication 144 of the amount of change from the comparative value and the current value for a particular metric. Furthermore, the amount of change may be color-coded to indicate whether the variance between the current and comparative values is positive or negative. Other columns 146 provide the corresponding benchmark data for the listed metrics. The benchmark data may be listed, for example, according to bottom quartile, median value and top quartile.

Positional boxes, such as the box 148, may be added adjacent the benchmark data to indicate the company's relative performance compared to the benchmark data. For example, a positional box 150 is provided in the row for the metric “PPE (Net)” under the category “Percent of Total Assets.” The current value for that metric—24.9%—falls between the bottom quartile and median benchmark values. Therefore, the positional box 150 appears between the bottom quartile and median benchmark values. Positional indicators other than boxes may be used in other implementations.

Directional arrows, such as the arrow 152, may be provided within some or all of the positional indicators to indicate the direction in which the particular company should try to move the value of the particular metric. For example, the directional arrow 152 indicates that the company should try to lower the value of the corresponding metric toward the top quartile benchmark value. On the other hand, the directional arrow within the positional box 150 indicates that the company should try to lower the value of the corresponding metric toward the bottom quartile benchmark value.

In addition, the directional arrows 152 or other symbols may be color-coded to grade the company's performance and indicate how far from a desired value the company is for a particular metric. For example, if the preferred direction for a particular metric is toward the top quartile, and the positional indicator appears to the left of the bottom quartile, then, in one particular implementation, the directional arrow would be red. If the company's performance with respect to a particular metric were good, then the directional arrow would be green. Additional colors may be used to grade the company's performance more finely along a spectrum.

As shown in the spreadsheet of FIG. 19, various columns may list the metric group, a description of the metric, the units in which the metric's value appears as well as the value for the particular company, and the bottom quartile, median and top quartile benchmark data values. In addition, boxes in the column 160 allow the user to selectively filter which metrics to view in the spreadsheet. Another column 162 (Target”) may be used to specify a target value for the particular metric or to specify whether the target value should be a low or high value. The information in column 164 (“Position”) may be used to specify the relative position of the particular company with respect to the benchmark data. For example, the position information may indicate that, for a particular metric, the company's performance is better than the top quartile benchmark value (“>Top”), lower than the bottom quartile benchmark value (“<B”), or falls between two of the listed benchmark values.

Additional columns 166, 168 provide scores and color-coded grades of the company's performance with respect to the benchmark data for the listed metrics. In the illustrated spreadsheet, the scores range from a value of four (indicating good performance) to a value of one (indicating poor performance). Similarly, the color-coded grades in column 168 may range from green (indicating good performance) to red (indicating poor performance).

When the user performs an action that causes the benchmark tool to export the data to a spreadsheet, the tool automatically may include the positional indicators, the directional arrows, the relative scoring and the color-coded grades in the displayed spreadsheet.

The benchmark tool also may include a “scenario analysis” feature that allows the user to vary the values for one or more metrics or business drivers and obtain an analysis of the hypothetical scenario. The benchmark tool automatically responds by providing the user with an analysis based on the hypothetical-rather than actual-values. The scenario analysis feature may be accessed, for example, by clicking a button 202 from the screens in FIGS. 9-12.

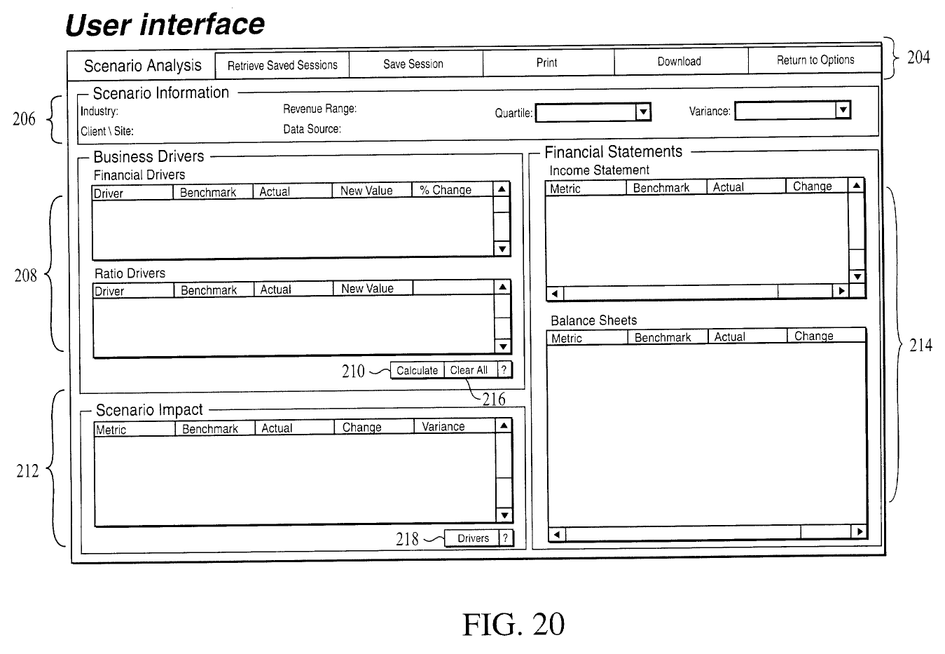

As illustrated in FIG. 20, the user interface for the scenario analysis feature may include a menu bar 204. The menu bar includes several options to allow the user to save a session or retrieve a saved session. Using those options, the user can save the selected industry, client/site and adjusted values, as well as access previously saved selections.

A second section 206 of the screen displays the industry and client/site information selected by the user. The user can choose from among various benchmark categories such as bottom quartile, top quartile or median, as well as what variance should be displayed.

A third section 208 of the screen displays business drivers such as financial ratios and metrics. To enter an adjusted value of adjusted percentage, the user may click on the driver name. Clicking the calculate button 210 results in changed values in the scenario impact section 212 and the financial statements section 214. Clicking the clear all button 216 removes the adjusted values and adjusted percentages.

The scenario impact section 212 displays the administrator-selected ratios and metrics. The column labeled “Change” reflects changes resulting from adjusted business drivers. An icon may indicate which items have been impacted by the adjusted business drivers. The drivers button 218 may be selected to highlight the financial statement accounts that drive the ratios and metrics checked by the user.

The financial statements section 214 displays balance sheet and income statement information and can display subtotals and totals as determined by the system administrator. An icon may indicate which items have been impacted by the adjusted business drivers.

The benchmark and actual data that appears in sections 208, 212 and 214 may be entered automatically by the benchmark tool based on user selections of industry and client/site. Favorable, unfavorable and neutral variances may be indicated through color-coding. Clicking on an account or metric may be used to access a corresponding definition of the account of metric.

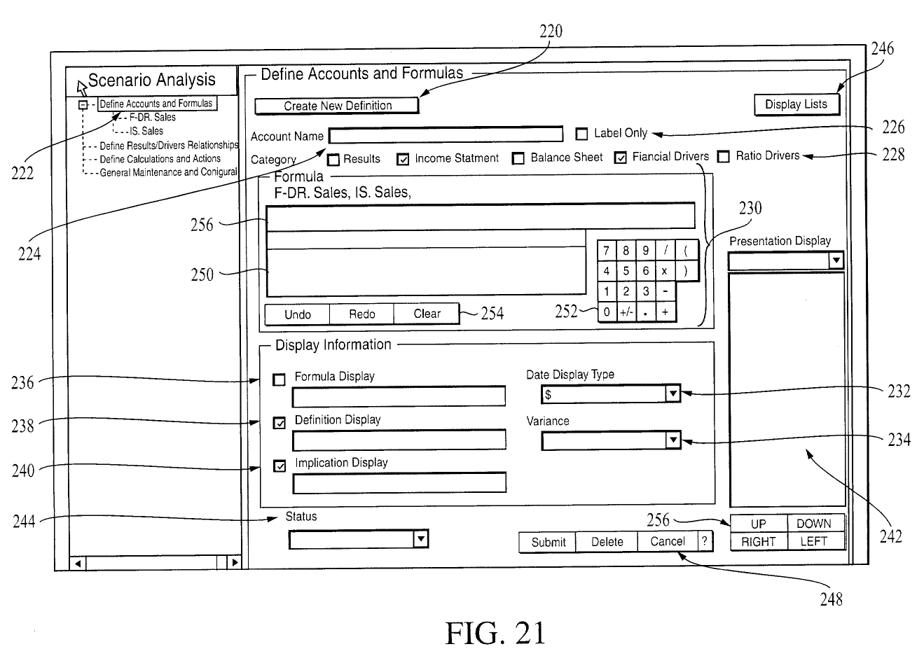

FIGS. 21-23 illustrate various administrative functions in connection with the scenario analysis feature. An administrator can define accounts and formulas from the screen shown in FIG. 21. A button 220 labeled “Create New Definition” allows the administrator to edit an “Account Name” section 224 by typing in a new account or metric name. The name is added automatically to the navigation box tree 222, and the name of the account or metric that is highlighted in the navigation box tree is displayed in the “Account Name” section 224.

If a particular account or metric has no underlying formula, the box 226 should be checked. This feature may be used to create titles. One or more category boxes 228 may be checked by the administrator to select where within the user interface (see FIG. 20) the account or metric will be displayed. Although the administrator may select more than one category, certain categories such as financial drivers and ratio drivers are mutually exclusive.

An expression builder section 230 allows the administrator to define the account or metric through a formula utilizing benchmark and actual company data as well as previously defined accounts and metrics. The administrator utilizes the list box 250, the keypad 252 and the buttons 254 to create definitions of the account or metric. The formula box 256 may be edited directly.

A drop-down menu 232 labeled “data display type” allows the administrator to select the type of data for the account or metric. Another drop-down menu 234 labeled “variance information” allows the administrator to select whether good performance is depicted by positive or negative fluctuations from the baseline.

The administrator may enter the formula underlying the account or metric in the formula display box 236 and may enter an explanatory definition in the definition display box 238. Implications or assumptions associated with the definition may be entered in the implication display box 240.

A presentation display 242 allows the administrator to select which category should be displayed. The accounts and metrics assigned to the selected category are presented in the presentation display box 242. The administrator can highlight the accounts or metrics and can use the up/down buttons 256 to move an item vertically. The left/right buttons 256 allow the administrator to indent items to indicate subtotals and headers.

A drop down menu 244 allows the administrator to select the level of completion or approval for the particular account or metric. A display lists button 246 provides a list of all created accounts and metrics as well as the corresponding formulas and related properties.

Other action buttons 248 allow the administrator to save the information entered and validates the formula entered, to delete an account from the database or to cancel the work in progress and clear the screen.

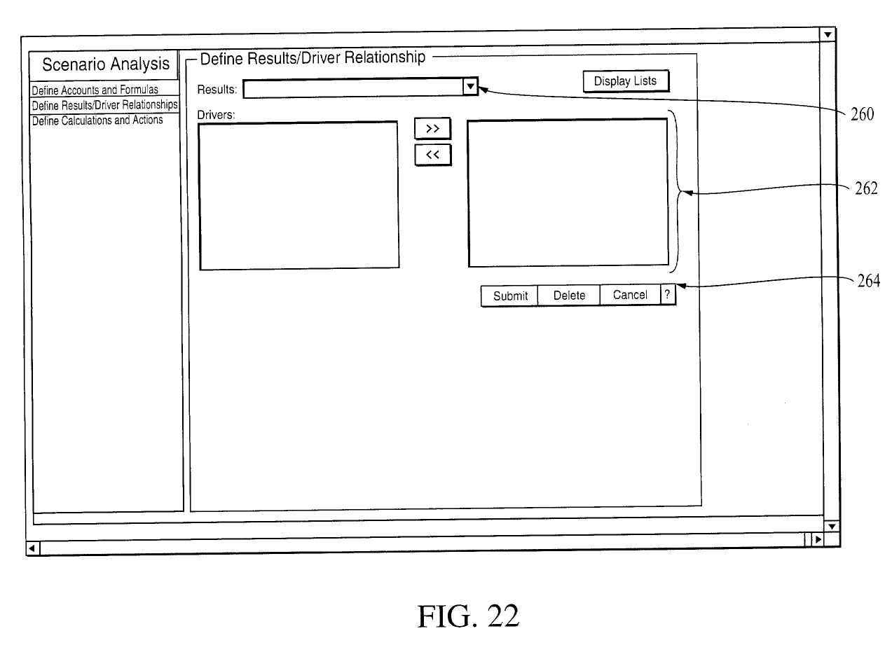

Another screen, shown in FIG. 22, allows the administrator to define the relationship between the results and drivers, in other words, to identify which business drivers drive the accounts or metrics. The administrator may select results from a drop down list 260 of ratios and metrics. The defined drivers are displayed in the list boxes 262. The administrator may select a driver from the left list box and move it to the right list box to indicate items which are drivers of the selected scenario impact account or metric. Various action buttons 264 allow the administrator to save the information to the database, to delete the relationship, or to cancel the work in progress and clear the screen.

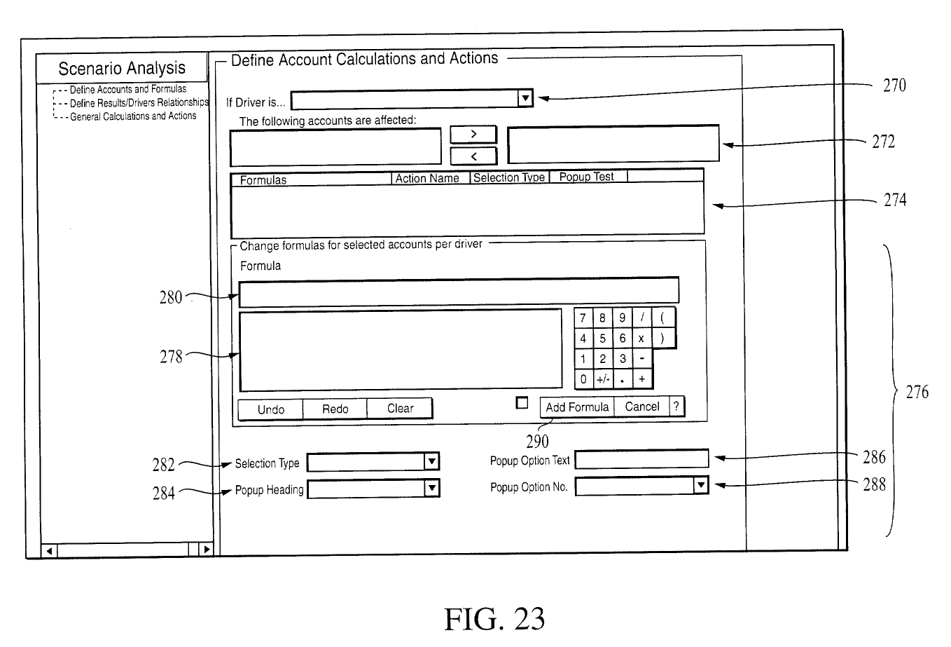

The administrator can define account calculations and actions from the screen shown in FIG. 23. In particular, the administrator can define financial statement change calculations that are directly impacted by adjusted driver values and adjusted percentages.

The administrator selects a driver from drop-down menu 270 and selects financial statement accounts that are directly affected by the adjusted driver values using the list boxes 272. For each account affected, there is at least one formula that defines how the account is affected by the adjusted driver. The formulas box 274 lists the formulas that are affected by the selected account. The expression builder section 276 of the screen may be used by the administrator to create formulas for a selected account. A list box 278 displays the driver and financial statement items that can be used to create formulas for calculating financial statement change values. The expression window 280 displays the formula being created through use of the keypad and undo/redo/clear buttons. The expression window may be edited directly.

If there is more than one formula listed for an account affected by a given driver, the user chooses a particular formula or option from the drop-down menu 282. In that case, three additional pop-up menus 284, 286, 288 become active to allow the user to make a selection when a change in a driver has multiple possible impacts on the financial statements. The first pop-up menu 284 is used to name the pop-up and also serves as the headlining text of the pop-up. The second pop-up menu 286 provides a descriptive text for each option choice. The third pop-up menu 288 allows formulas to be grouped to the same option so that users can make a single choice that impacts multiple accounts.

The button 290 labeled “add formula” instructs the system to apply the entered formula and add it to the list. The button 292 labeled “cancel” allows the user to cancel the work in progress.

Various aspects of the system may be implemented in hardware, software or a combination of hardware and software. Dedicated or general purpose machines, such as processors, may be adapted to execute machine-readable instructions to implement the techniques described above. Computer-executable instructions for implementing the techniques can be stored, for example, as encoded information on a computer-readable medium such as a magnetic floppy disk, magnetic tape, or compact disc read only memory (CD-ROM).

Other implementations are within the scope of the claims.

What is claimed is:

1. A method comprising:
receiving, in a computer system, user input specifying a dataset and a display format; and
displaying aggregated benchmark data based on the received user input specifying the dataset and the display format.

2. The method of claim 1 wherein the benchmark data comprises financial or operational data.

3. The method of claim 1 including:
receiving user input specifying a dataset corresponding to a particular industry; and
displaying aggregated benchmark data for the particular industry in the specified display format.

4. The method of claim 1 including:
receiving user input specifying a dataset corresponding to a particular geographical area; and
displaying aggregated benchmark data for the particular geographical area in the specified display format.

5. The method of claim 1 including:
receiving user input specifying one or more metrics; and
displaying benchmark data for the specified one or more metrics in the specified display format.

6. The method of claim 1 including:
receiving user input specifying one or more revenue ranges; and
displaying benchmark data in the specified display format for companies having an annual revenue in the specified one or more revenue ranges.

7. The method of claim 1 including:
receiving user input specifying one or more revenue ranges and one or more metrics; and
displaying benchmark data in the specified display format for the specified one or more metrics based on companies having an annual revenue in the specified one or more revenue ranges.

8. The method of claim 7 including displaying benchmark data separately for each metric in each of the specified one or more revenue ranges.

9. The method of claim 1 including:
receiving user input specifying whether to display the benchmark data in a table or chart format; and
displaying the benchmark data in the format specified by the user input.

10. The method of claim 1 including:
receiving user input specifying a type of chart in which to display the benchmark data; and
displaying the benchmark data in the type of chart specified by the user input.

11. The method of claim 10 including:
receiving user input indicating whether the benchmark data should be displayed as three-dimensional; and
displaying the benchmark data in accordance with the user input indicating whether the benchmark data should be displayed as three-dimensional.

12. The method of claim 1 including:
receiving user input specifying a revenue range and a metric and further specifying at least one segment of benchmark data for that metric and revenue range; and
displaying the specified at least one segment of benchmark data for the specified metric based on companies having an annual revenue in the specified revenue range.

13. The method of claim 1 including:
receiving, in the computer system, data representing financial or operational performance of a particular entity;
executing at least one arithmetic or statistical formula to identify a potential omission or error in the received data; and
displaying a message indicating a potential omission or error in the received data.

14. The method of claim 1 including:
receiving, in the computer system, data representing financial or operational performance of a particular entity;
validating the received data; and
incorporating the received data into an aggregated benchmark dataset available for display to a user.

15. The method of claim 1 including displaying financial or operational data for a particular entity together with the aggregated benchmark data.

16. The method of claim 1 including exporting the displayed data to a spreadsheet.

17. The method of claim 1 including:
displaying financial or operational data for a particular entity together with the aggregated benchmark data;
exporting the displayed data to a spreadsheet; and
displaying an indicator on the spreadsheet indicating relative values between the particular entity and the aggregated benchmark data with respect to a particular metric.

18. The method of claim 17 wherein displaying an indicator on the spreadsheet includes displaying color-coded indicator.

19. The method of claim 17 wherein displaying an indicator on the spreadsheet includes displaying a positional box.

20. The method of claim 17 including displaying a directional arrow on the spreadsheet to indicate a direction in which the entity should try to move with respect to a particular metric.

21. The method of claim 17 including displaying a color-coded symbol on the spreadsheet to indicate how far the entity is from a desired value with respect to a particular metric.

22. An article comprising a machine-readable medium storing machine-executable instructions that, when applied to a machine, cause the machine to display aggregated benchmark data for a particular dataset in a specified display format in response to user input specifying the dataset and the display format.

23. The article of claim 22 wherein the benchmark data comprises financial or operational data.

24. The article of claim 22 including instructions that, when applied to the machine, cause the machine to display aggregated benchmark data for a particular industry in the specified display format in response to user input specifying the industry and the display format.

25. The article of claim 22 including instructions that, when applied to the machine, cause the machine to display aggregated benchmark data for a particular geographical area in the specified display format in response to user input specifying the geographical area and the display format.

26. The article of claim 25 including instructions that, when applied to the machine, cause the machine to display aggregated benchmark data for a specified one or more metrics in response to user input specifying the one or more metrics.

27. The article of claim 22 including instructions that, when applied to the machine, cause the machine to display aggregated benchmark data in the specified display format for companies having an annual revenue in one or more revenue ranges in response to user input specifying the one or more revenue ranges.

28. The article of claim 22 including instructions that, when applied to the machine, cause the machine to display aggregated benchmark data in the specified display format for one or more metrics based on companies having an annual revenue in the specified one or more revenue ranges in response to user input specifying the one or more revenue ranges and the one or more metrics.

29. The article of claim 28 including instructions that, when applied to the machine, cause the machine to display benchmark data separately for each metric in each of the specified one or more revenue ranges.

30. The article of claim 22 including instructions that, when applied to the machine, cause the machine to display the benchmark data in either a table or chart format in response to user input specifying the display format.

31. The article of claim 30 including instructions that, when applied to the machine, cause the machine to display the benchmark data in a type of chart specified by the user input.

32. The article of claim 31 including instructions that, when applied to the machine, cause the machine to display the benchmark data in accordance with user input indicating whether the benchmark data should be displayed as three-dimensional.

33. The article of claim 32 including instructions that, when applied to the machine, cause the machine to display a specified segment of aggregated benchmark data for a specified metric based on companies having an annual revenue in a specified revenue range in response to user input specifying the segment, the metric and the revenue range.

34. The article of claim 22 including instructions that, when applied to the machine, cause the machine to:
execute at least one arithmetic or statistical formula to identify a potential omission or error in response to receiving data representing financial or operational performance of a particular entity; and
display a message indicating a potential omission or error in the received data.

35. The article of claim 22 including instructions that, when applied to the machine, cause the machine to:
validate received data representing financial or operational performance of a particular entity; and
incorporate the received data into an aggregated benchmark dataset available for display to a user.

36. The article of claim 22 including instructions that, when applied to the machine, cause the machine to display financial or operational data for a particular entity together with the displayed aggregated benchmark data in response to a user request.

37. The article of claim 22 including instructions that, when applied to the machine, cause the machine to export the displayed data to a spreadsheet in response to a user request.

38. The article of claim 22 including instructions that, when applied to the machine, cause the machine to:
display financial or operational data for a particular entity together with the displayed aggregated benchmark data;
export the displayed data to a spreadsheet; and
display an indicator on the spreadsheet indicating relative values between the particular entity and the aggregated benchmark data with respect to a particular metric.

39. The article of claim 22 including instructions that, when applied to the machine, cause the machine to:
display a color-coded indicator on the spreadsheet to indicate relative values between the particular entity and the aggregated benchmark data with respect to a particular metric.

40. The article of claim 22 including instructions that, when applied to the machine, cause the machine to:
display a positional box on the spreadsheet to indicate relative values between the particular entity and the aggregated benchmark data with respect to a particular metric.

41. The article of claim 22 including instructions that, when applied to the machine, cause the machine to:
display a directional arrow on the spreadsheet to indicate a direction in which the entity should try to move with respect to a particular metric.

42. The article of claim 22 including instructions that, when applied to the machine, cause the machine to:
display a color-coded symbol on the spreadsheet to indicate how far the entity is from a desired value with respect to a particular metric.

43. An apparatus comprising:
a display;
a user input device;
a processor coupled to the display and the user input device; and
a machine-readable medium coupled to the processor, the machine-readable medium storing machine-executable instructions that, when applied to the processor, cause the processor to display on the display aggregated benchmark data for a particular dataset in a specified display format in response to user input specifying the dataset and the display format.

44. The apparatus of claim 43 wherein the benchmark data comprises financial or operational data.

45. The apparatus of claim 45 wherein the machine-readable medium includes instructions that, when applied to the processor, cause the processor to display on the display aggregated benchmark data for a particular industry in the specified display format in response to user input specifying the industry and the display format.

46. The apparatus of claim 43 wherein the machine-readable medium includes instructions that, when applied to the processor, cause the processor to display on the display aggregated benchmark data for a particular geographical area in the specified display format in response to user input specifying the geographical area and the display format.

47. The apparatus of claim 43 wherein the machine-readable medium includes instructions that, when applied to the processor, cause the processor to display on the display aggregated benchmark data for a specified one or more metrics in response to user input specifying the one or more metrics.

48. The apparatus of claim 43 wherein the machine-readable medium includes instructions that, when applied to the processor, cause the processor to display on the display aggregated benchmark data in the specified display format for companies having an annual revenue in one or more revenue ranges in response to user input specifying the one or more revenue ranges.

49. The apparatus of claim 43 wherein the machine-readable medium includes instructions that, when applied to the processor, cause the processor to display on the display aggregated benchmark data in the specified display format for one or more metrics based on companies having an annual revenue in the specified one or more revenue ranges in response to user input specifying the one or more revenue ranges and the one or more metrics.

50. The apparatus of claim 49 wherein the machine-readable medium includes instructions that, when applied to the processor, cause the processor to display on the display benchmark data separately for each metric in each of the specified one or more revenue ranges.

51. The apparatus of claim 43 wherein the machine-readable medium includes instructions that, when applied to the processor, cause the processor to display on the display the benchmark data in either a table or chart format in response to user input specifying the display format.

52. The apparatus of claim 43 wherein the machine-readable medium includes instructions that, when applied to the processor, cause the processor to display on the display the benchmark data in a type of chart specified by the user input.

53. The apparatus of claim 52 wherein the machine-readable medium includes instructions that, when applied to the processor, cause the processor to display on the display the benchmark data in accordance with user input indicating whether the benchmark data should be displayed as three-dimensional.

54. The apparatus of claim 43 wherein the machine-readable medium includes instructions that, when applied to the processor, cause the processor to display on the display a specified segment of aggregated benchmark data for a specified metric based on companies having an annual revenue in a specified revenue range in response to user input specifying the segment, the metric and the revenue range.

55. The apparatus of claim 43 wherein the machine-readable medium includes instructions that, when applied to the processor, cause the processor to:
execute at least one arithmetic or statistical formula to identify a potential omission or error in response to receiving data representing financial or operational performance of a particular entity; and
display a message indicating a potential omission or error in the received data.

56. The apparatus of claim 43 wherein the machine-readable medium includes instructions that, when applied to the processor, cause the processor to:
validate received data representing financial or operational performance of a particular entity; and
incorporate the received data into an aggregated benchmark dataset available for display to a user.

57. The apparatus of claim 43 wherein the machine-readable medium includes instructions that, when applied to the processor, cause the processor to display on the display financial or operational data for a particular entity together with the displayed aggregated benchmark data in response to a user request.

58. The apparatus of claim 43 wherein the machine-readable medium includes instructions that, when applied to the processor, cause the processor to export the displayed data to a spreadsheet in response to a user request.

59. The apparatus of claim 43 wherein the machine-readable medium includes instructions that, when applied to the processor, cause the processor to:
display financial or operational data for a particular entity together with the displayed aggregated benchmark data in response to a user request;
export the displayed data to a spreadsheet in response to a user request; and
display an indicator on the spreadsheet indicating relative values between the particular entity and the aggregated benchmark data with respect to a particular metric.

60. The apparatus of claim 59 wherein the machine-readable medium includes instructions that, when applied to the processor, cause the processor to:
display a color-coded indicator on the spreadsheet to indicate relative values between the particular entity and the aggregated benchmark data with respect to a particular metric.

61. The apparatus of claim 59 wherein the machine-readable medium includes instructions that, when applied to the processor, cause the processor to:
display a positional box on the spreadsheet to indicate relative values between the particular entity and the aggregated benchmark data with respect to a particular metric.

62. The apparatus of claim 59 wherein the machine-readable medium includes instructions that, when applied to the processor, cause the processor to:
display a directional arrow on the spreadsheet to indicate a direction in which the entity should try to move with respect to a particular metric.

63. The apparatus of claim 59 wherein the machine-readable medium includes instructions that, when applied to the processor, cause the processor to:
display a color-coded symbol on the spreadsheet to indicate how far the entity is from a desired value with respect to a particular metric.

64. The apparatus of claim 43 wherein the machine-readable medium includes instructions that, when applied to the processor, cause the processor to:
provide an analysis for a hypothetical scenario based on user input specifying a hypothetical value for a metric or business driver.

65. The apparatus of claim 64 wherein the machine-readable medium includes instructions that, when applied to the processor, cause the processor to:
display a screen on the display to allow an administrator to add or delete available metrics for use in the hypothetical analysis.

66. The apparatus of claim 64 wherein the machine-readable medium includes instructions that, when applied to the processor, cause the processor to:
display a screen on the display to allow an administrator to define relationships between business drivers and metrics for use in the hypothetical analysis.
